(19) United States
(12) Patent Application Publication
(10) Pub. No.: US 2024/0412023 A1
(43) Pub. Date: Dec. 12, 2024

(54) IMAGE PROCESSING APPARATUS, CONTROL METHOD OF IMAGE PROCESSING APPARATUS, AND STORAGE MEDIUM

(71) Applicant: CANON KABUSHIKI KAISHA, Tokyo (JP)

(72) Inventor: SHINICHI CHIBA, Tokyo (JP)

(21) Appl. No.: 18/732,135

(22) Filed: Jun. 3, 2024

(30) Foreign Application Priority Data
Jun. 7, 2023 (JP) 2023-093754

(51) Int. Cl. G06K 15/00

(52) U.S. Cl. CPC G06K 15/407; G06K 15/002

(57) ABSTRACT

An image processing apparatus includes a reception unit capable of providing a reception screen that receives an input of identification information of a predetermined type of part attachable to the image processing apparatus, a registration unit configured to register the identification information in response to the input of the identification information received by the reception unit, and a display unit configured to, if a number of pieces of the identification information previously registered in the registration unit has reached an upper limit on a registerable number in the registration unit and the reception unit has received the input of the identification information, display a notification screen that includes at least the identification information that is different from the identification information received by the reception unit and the identification information previously registered in the registration unit.

### BACKGROUND

### Field

The present disclosure relates to an image processing apparatus, a control method of an image processing apparatus, and a storage medium.

### Description of the Related Art

There are known technologies by which to count the used amounts of consumables of an image processing apparatus and notify the remaining lifetimes of the consumables obtained from the counted values. For example, Japanese Patent Application Laid-Open No. 2003-241584 discusses displaying a confirmation screen for prompting the user to confirm whether to reset the count value, based on the attachment and detachment of a consumable to and from the image processing apparatus.

### SUMMARY

According to an aspect of the present disclosure, an image processing apparatus includes a reception unit configured to provide a reception screen that receives an input of identification information of a predetermined type of part attachable to the image processing apparatus, a registration unit configured to register the identification information in response to the input of the identification information received by the reception unit, and a display unit configured to, if a number of pieces of the identification information previously registered in the registration unit has reached an upper limit on a registerable number in the registration unit and the reception unit has received the input of the identification information, display a notification screen that includes at least the identification information that is different from the identification information received by the reception unit and the identification information previously registered in the registration unit.

Further features of the present disclosure will become apparent from the following description of exemplary embodiments with reference to the attached drawings.

### BRIEF DESCRIPTION OF THE DRAWINGS

FIG. 1 is a block diagram of an image processing apparatus.

FIGS. 2A and 2B are explanatory diagrams describing an operator maintenance mode.

FIG. 3 is an explanatory diagram describing a management method of fixing unit information.

FIG. 4 is an explanatory diagram describing a notification screen of fixing unit information registration.

FIG. 5 is a flowchart of execution of fixing unit registration.

FIG. 6 is an explanatory diagram describing a notification screen of fixing unit information registration.

### DESCRIPTION OF THE EMBODIMENTS

Hereinafter, exemplary embodiments for carrying out the present disclosure will be described with reference to the drawings. The following exemplary embodiments are not intended to limit the disclosure according to the claims. In addition, all of combinations of features in the exemplary embodiments are not necessarily essential for the solution provided by the disclosure.

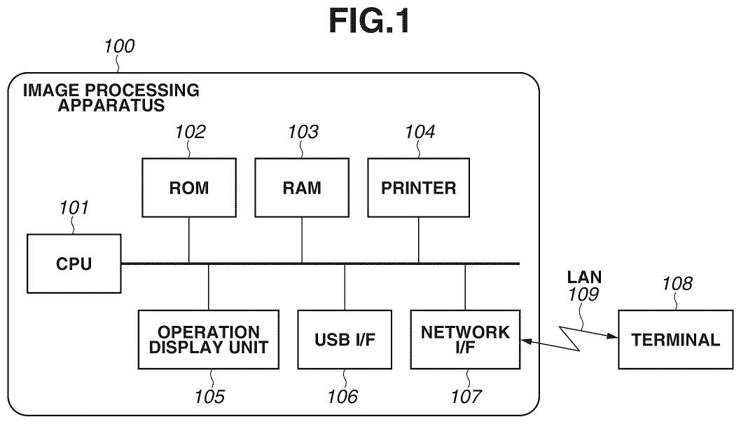

A first exemplary embodiment will be described. FIG. 1 is a diagram illustrating a configuration of an image processing apparatus 100.

Referring to FIG. 1, the image processing apparatus 100 has a central processing unit (CPU) 101, a read-only memory (ROM) 102, a random-access memory (RAM) 103, a printer 104, and an operation display unit 105. The printing method of the printer 104 used in the present exemplary embodiment may be the electrophotographic method, the inkjet method, or another method. The image processing apparatus 100 also has, as communication interfaces with external devices, a universal serial bus (USB) interface (I/F) 106 and a network I/F 107.

The CPU 101 is a system control unit that controls the overall image processing apparatus 100.

The ROM 102 stores a control program of the CPU 101. The control program is a control program that implements the exemplary embodiment described below. The type of the ROM 102 is a writable flash ROM or the like. The ROM 102 stores setting values registered by the user of the image processing apparatus 100, management data, and others. The time-zone setting in the present exemplary embodiment is saved in the ROM 102. The control program can be updated by an external input, and this is called software upgrade in the present exemplary embodiment. When the software is upgraded, the contents of the control of the CPU 101 are changed from those before the upgrade.

The RAM 103 stores execution programs, program control variables, a buffer for various types of work, some of setting values registered by the user of the image processing apparatus 100, management data, and others.

The printer 104 records received images and file data on recording paper.

The operation display unit 105 is formed of a numeric keypad, a keyboard, a touch panel, a liquid crystal display (LCD), a light-emitting diode (LED), and others, and receives various operations performed by the user, displays an operation screen, and provides notification to the user.

The USB I/F 106 makes a connection to a USB device, communicates with the USB device, and supplies electric power to the USB device.

The network I/F 107 enables transmission and reception of data between a terminal 108 and the components of the image processing apparatus 100 via a local area network (wireless LAN/wired LAN) 109. The communication method used for connection between the devices is IEEE802.11-series communication standard (Wi-Fi) or Bluetooth® (Bluetooth Classic, Bluetooth Low Energy (BLE) or the like), for example. The terminal 108 in the present exemplary embodiment is a smartphone, a tablet, a personal computer (hereinafter, PC), or the like, and has a browser display function. The terminal 108 also includes a touch panel and a keyboard function for performing operations, and enables input and output from and to the user.

In the present exemplary embodiment, the parts attached to the image processing apparatus 100 such as a toner cartridge and a fixing unit (fixing device) may become consumed or deteriorated in accordance with the usage condition, and need maintenance work such as replacement. For example, the consumables (consumable parts) such as a toner cartridge are consumed in accordance with the usage condition and need replacement. In addition, the fixing unit is a part that applies heat and pressure to an unfixed toner image on a recording medium in an electrophotographic image formation apparatus to fix the toner image to the recording medium. In the present exemplary embodiment, the “consumable parts” include parts that become consumed or deteriorated. The parts to which the present exemplary embodiment is applicable are not limited to parts that become consumed or deteriorated.

The fixing unit in the present exemplary embodiment has a heating unit. The heating unit has a fixing film and a heater that heats the fixing film. The fixing film heated by the heater contacts a recording medium and heats the recording medium.

The fixing unit further has a pressure roller and contacts the outer peripheral surface of the fixing film to form a nip portion. The pressure roller is connected to a drive source and is rotationally driven by the drive source, and the fixing film rotates following the rotation of the pressure roller. When the recording medium is conveyed to the nip portion, the recording medium is subject to heat and pressure while being conveyed by the pressure roller and the fixing film. Accordingly, the toner on the recording medium is fixed to the recording medium. The fixing device is not limited to this configuration and may be a roller pair that can fix the toner. The image processing apparatus 100 has, as a function related to maintenance work of the parts, an operator maintenance mode that is a mode for supporting maintenance work by a general user (or an administrative user). In the operator maintenance mode, for example, the consumption degree of a consumable part is checked, and when the consumable part has reached the life limit value, the consumption degree of the consumable part is reset after replacement. Since the consumption degree and life limit value based on the consumption degree vary among individual consumable parts, it is necessary to identify individual consumable parts currently attached to the image processing apparatus and manage information related to the individual consumable parts (for example, count value of the consumption degree). As a method for identifying each individual consumable part, for example, an electronic chip is attached to the consumable part, and the image processing apparatus 100 reads individual identification information for identifying the individual consumable part (for example, identification number) saved in a memory included in the electronic chip to automatically identify the individual consumable part. However, some image processing apparatus 100 may not have the function of reading an electronic chip. In this case, the user manually inputs the individual identification information of a consumable part so that the image processing apparatus 100 can identify the consumable part. The operator maintenance mode is a mode that is different from a serviceman mode in which a serviceman, not a user, performs maintenance and parameter adjustment of the image processing apparatus.

In the case where the individual identification information of a consumable part is manually input by the user to the image processing apparatus 100, if a reset operation is wrongly performed, the information related to the consumable part may not be managed properly. For example, if there is the upper limit value of the number of storable (savable) pieces of individual identification information of consumable parts in the image processing apparatus 100 and a new piece of individual identification information of a consumable part is input in the state where the upper limit value is reached, the information related to a consumable part with individual identification information of which the input date is older (earlier) is deleted. In this case, if there is an error in the new individual identification information of the consumable part that is input in the state where the upper limit value is reached due to the user's mistake in operation, for example, the erroneous individual identification information of the consumable part is newly registered (saved), the previously registered individual identification information of the consumable part is deleted. That is, the unintended registration of the individual information is executed, so that the consumable part may not be properly managed and the user convenience may become deteriorated. There may be a plurality of numbers of storable (savable) pieces of individual identification information of the same kind of consumable parts. This is because the image processing apparatus 100 may be configured such that, while a first part is replaced, a second part that is the same kind as the first part but is different from the first part is attached to the image processing apparatus 100 in order to make the image processing apparatus 100 usable even during replacement of the first part. Therefore, the image processing apparatus 100 saves a plurality of pieces of individual identification information of a plurality of parts of the same kind.

Thus, in the present exemplary embodiment, if there is an upper limit on the number of storable pieces of individual identification information of consumable parts and a new piece of individual identification information of a consumable part is input in the state where the upper limit value is reached, a notification screen is displayed to prompt the user to confirm whether to execute the registration process on the basis of the input information.

This reduces the unintended registration of individual identification information and achieves proper management of the consumable parts, thereby improving user convenience.

In the present exemplary embodiment, as a part of one kind, a toner fixing unit will be taken as an example, but the present disclosure is not limited to this part. The part may be a predetermined part that is attachable to the image processing apparatus 100. For example, the predetermined part may be a conveyance roller, a drum unit, a toner cartridge, or the like. If the image processing apparatus 100 is an inkjet printer, the predetermined part may be an ink cartridge or an ink head that discharges ink.

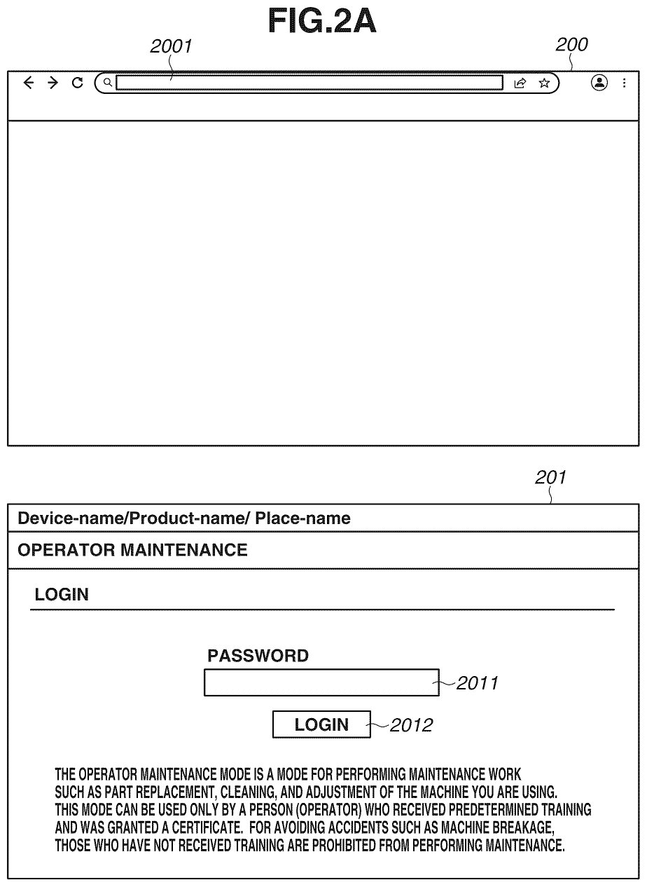

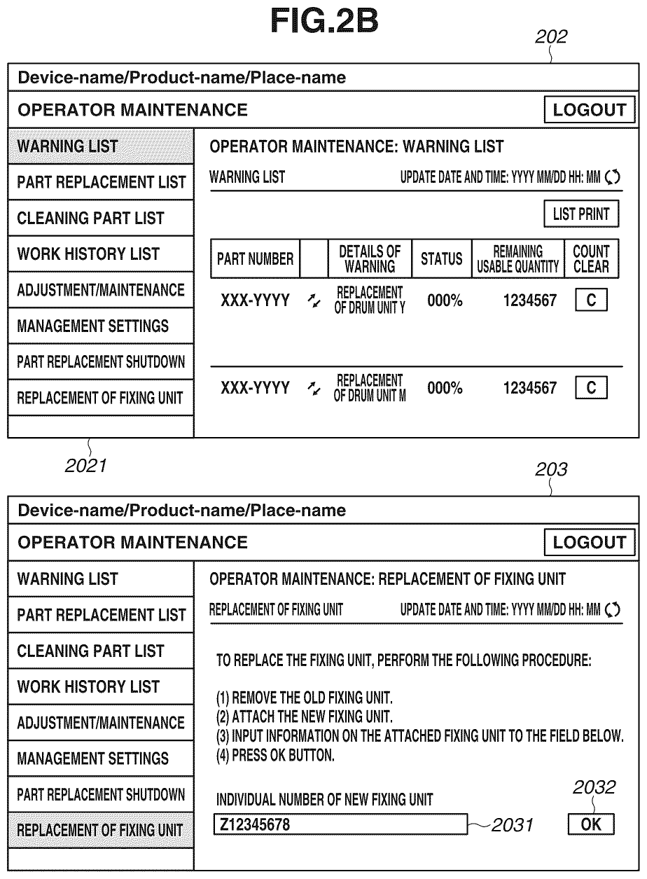

FIG. 2 is a diagram describing the operator maintenance mode. In the operator maintenance mode according to the present exemplary embodiment, when the browser function of the terminal 108 is used, an operation screen corresponding to the operator maintenance mode is displayed.

An initial screen 200 is a screen that is displayed when the browser function of the terminal 108 is first activated. FIG. 2 illustrates the initial screen on which no information is displayed, but various kinds of information on the internet may be displayed on the initial screen. On the initial screen 200, the user inputs address information for accessing the operator maintenance mode in an address input field 2001. In the present exemplary embodiment, the settings related to the image processing apparatus 100 are made by using a remote UI function that is a function settable in the terminal 108 connected via a network. For example, the operator maintenance mode can be accessed by using the IP address of the image processing apparatus 100. Specifically, if the IP address of the image processing apparatus 100 is 172.0.0.1, when “https://172.0.0.1/operatormaintenance” is input to the address input field 2001, the terminal 108 can access the operator maintenance mode in the image processing apparatus 100.

A login screen 201 is a screen that is displayed when the process of accessing the operator maintenance mode is executed on the initial screen 200, and is a screen for executing an operation of logging in to the operator maintenance mode. When a password is input to a password input field 2011 and a login button 2012 is pressed, the login process is executed. On the login screen 201, information related to execution of maintenance work in the operator maintenance mode (warning message) may be displayed.

A warning list screen 202 is a screen that is displayed when the process of logging in to the operator maintenance mode succeeds. Displayed on the warning list screen 202 are a list of consumable parts the values of which indicating the consumed state have exceeded a predetermined value. Transition can be made from a menu area 2021 on the left part of the warning list screen 202 to a screen corresponding to the maintenance work to be performed. For example, selecting the item “Replacement of Fixing Unit” makes a transition from the warning list screen 202 to a fixing unit replacement screen 203.

The fixing unit replacement screen 203 is a screen that is displayed in replacing the fixing unit that is one kind of maintenance work in the present exemplary embodiment. New individual information “212345678” is input to a fixing unit information input field 2031, and a confirmation button 2032 is pressed to confirm the fixing unit information. Accordingly, the information related to the fixing unit is saved in the RAM 103.

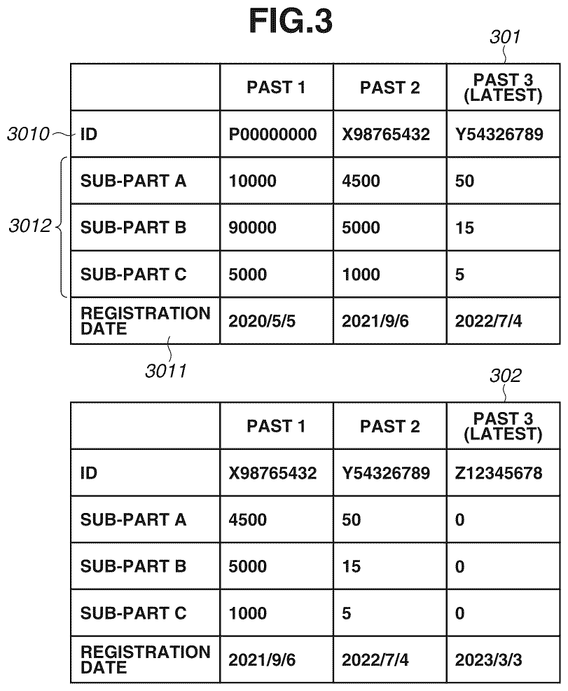

FIG. 3 is an explanatory diagram describing a management table of information related to fixing units saved in the RAM 103.

A management table 301 indicates the saved state of the information related to fixing units at certain points of time in the RAM 103. In the present exemplary embodiment, up to three pieces of information related to fixing units, “Past 1”, “Past 2”, and “Past 3 (latest)” can be registered in order in which they were attached to the image processing apparatus 100. The upper limit on the registerable number of pieces of information is not limited to this and may be any predetermined value. The “Past 3 (latest)” indicates the currently attached consumable part. For example, the currently attached fixing unit is “Y54326789”. The “ID” 3010 is a section indicating the ID that is the individual identification information of the fixing unit. In association with the individual identification information, information related to the registration date and information related to sub-parts of the fixing unit are also saved. The “registration date” 3011 is a section that indicates the date and time when the individual identification information was saved. The “sub-part group” 3012 is a section that indicates the consumed state of each sub-part of the attached fixing unit. The sub-parts include a fixing film and a heater that heats the fixing film, for example. In registering the information related to the fixing unit, first, the individual identification information is saved in the “ID” 3010 indicating the ID that is the individual identification information of the fixing unit, and then the registration date and time is saved in the “registration date” 3011 indicating the registration date and time. For example, in the management table 301, the fixing unit with the ID “P00000000” was attached on “May 5, 2020” and is the oldest individual among the fixing units currently stored in the image processing apparatus 100, and the consumption degree (state) of an accompanying sub-part A is “10000”, the consumption degree (state) of a sub-part B is “90000”, and the consumption degree (state) of a sub-part Cis “5000”. The values of the consumption degrees indicating the consumed states of the sub-parts are examples, and each part has a predetermined value. For example, a predetermined value indicating the consumption degree of a predetermined part is a value related to the use of the predetermined part, such as the number of times when the predetermined part was operated or the number of jobs that were performed using the predetermined part. When the value indicating the consumption degree reaches a predetermined life limit value indicating the time for part replacement, it is determined that the time for part replacement has come.

A management table in the case where a fixing unit with individual identification information “Z12345678” is newly registered on the fixing unit replacement screen 203 will be described as a management table 302. The value “Z12345678” is registered in the section of the “ID” 3010 of “Past 3 (latest)”. Since this individual identification information is different from the individual identification information of the fixing units currently stored in the image processing apparatus 100, the consumed states of the sub-parts have an initial value of “0”

In the present exemplary embodiment, as the number of pieces of savable information related to fixing units is three, the management table 302 is updated such that the oldest individual identification information “P00000000” saved in the management table 301 is deleted, the individual identification information “X98765432” that is previously registered as “Past 2” is moved and saved in the section of “ID” 3010 of the “Past 1” column, and the individual identification information “Y54326789” that is previously registered as “Past 3 (latest)” is moved and saved in the section of “ID” 3010 of “Past 2”. If the same individual identification information as the individual identification information of the fixing unit currently stored in the image processing apparatus 100 is input, the management table is updated such that the information related to the input individual identification information is moved from the predetermined section where it is currently saved to the section of “Past 3 (latest)” in the management table. The values of the input individual identification information are not changed from the previously registered ones.

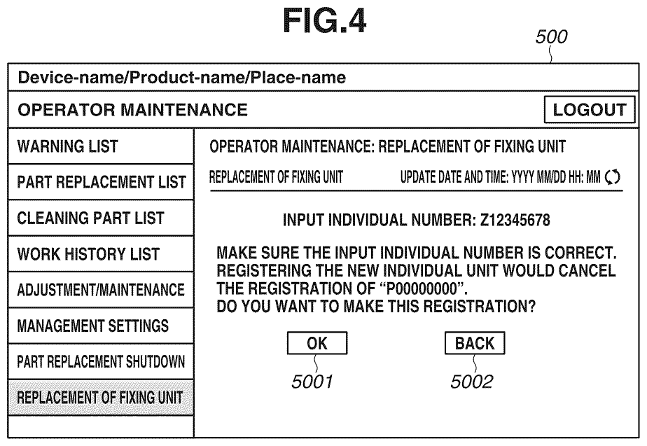

FIG. 4 is a diagram illustrating a screen for prompting the user to confirm whether to register the individual identification information input to the fixing unit information input field 2031 on the screen 203. In the present exemplary embodiment, a notification screen 500 is displayed when the confirmation button 2032 is pressed on the screen 203 illustrated in FIG. 2. Displayed on the notification screen 500 are information for prompting the user to confirm registration of the individual identification information input to the fixing unit information input field 2031 on the screen 203 and information indicating the individual identification information of the consumable part to be unregistered due to the registration of the input individual identification information. When a registration button 5001 on the notification screen 500 is pressed, the CPU 101 deletes the information related to the individual identification information of the consumable part to be unregistered, and registers the individual identification information input to the fixing unit information input field 2031 on the fixing unit replacement screen 203. If a back (cancel) button 5002 is pressed, the CPU 101 returns to the previous screen (screen 203) without registering the individual identification information input to the fixing unit information input field 2031 on the screen 203. The notification screen 500 may be a screen different from the screen on the browser, and may be displayed as a dialog, for example. Displayed on the notification screen 500 is at least the information indicating the individual identification information of the consumable part to be unregistered due to the registration of the input individual identification information.

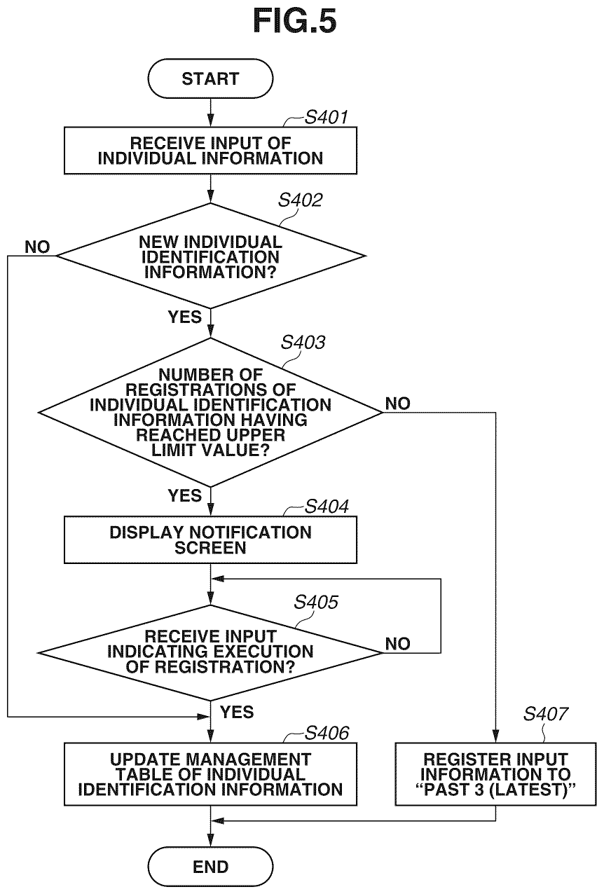

FIG. 5 is a flowchart of screen display at the time of replacement of the fixing unit. The processing in the flowchart is started when the operator maintenance mode is activated in the image processing apparatus 100. For example, the processing in the flowchart is started when the item “Replacement of fixing unit” is selected in a menu area 2021 on the left part of the warning list screen 202, which is the operation screen in the operator maintenance mode, and the fixing unit replacement screen 203 is displayed. The processing in the flowchart may be started not only when the image processing apparatus 100 is in the operator maintenance mode but also when the time for replacement of a part attachable to the image processing apparatus 100 has come. In step S401, the CPU 101 displays the fixing unit replacement screen 203, receives an input of individual identification information to the fixing unit information input field (area) 2031, and detects the press of the confirmation button 2032.

In step S402, the CPU 101 determines whether the individual identification information input in step S401 is new information that has not been input in the past. That is, the CPU 101 determines whether individual identification information different from the currently registered individual identification information has been input. If the determination result is affirmative in step S402 (YES in step S402), the processing proceeds to step S403. If the determination result is negative in step S402 (NO in step S402), the processing proceeds to step S406.

In step S403, the CPU 101 determines whether the number of pieces of individual identification information registered in the management table 301 has reached a predetermined upper limit. For example, since up to three pieces of information related to the fixing unit can be registered in the image processing apparatus 100 according to the present exemplary embodiment, the predetermined upper limit is “three”. Therefore, the CPU 101 determines whether the number of pieces of individual identification information registered in the management table 301 has reached the predetermined upper limit “three”. If the determination result is affirmative in step S403 (YES in step S403), the processing proceeds to step S404. If the determination result is negative in step S403 (NO in step S403), the processing proceeds to step S407.

In step S407, the CPU 101 saves the individual identification information input in step S401 and its related information in the area of “Past 3 (latest)” in the management table 301 illustrated in FIG. 3. The CPU 101 does not delete the oldest individual identification information, among the currently registered individual identification information, and the information associated with the oldest individual identification information. In addition, the CPU 101 does not display a screen for prompting the user to confirm whether to register the individual identification information such as the notification screen 500.

In step S404, the CPU 101 displays the notification screen 500 for prompting the user to confirm whether to register the individual identification information.

In step S405, the CPU 101 determines whether an input indicating the execution of registration of the individual identification information has been received. For example, the CPU 101 determines whether the registration button 5001 has been pressed or the back button 5002 has been pressed on the notification screen 500. If the registration button 5001 on the notification screen 500 has been pressed (in step S405), the CPU 101 makes an affirmative determination in step S405. If the back 5002 is pressed, the CPU 101 makes a negative determination in step S405. If the determination result is affirmative in step S405 (YES in step S405), the processing proceeds to step S406. If the determination result is negative in step S405 (NO in step S405), the processing repeats step S405.

If the determination result is affirmative in S405 (that is, an instruction for the registration of the individual identification information different from the currently registered individual identification information has been received), in subsequent step S406, the CPU 101 updates the management table, and the processing in the flowchart is ended. For example, the CPU 101 updates the management table 301 illustrated in FIG. 3 to the management table 302. Specifically, the CPU 101 saves (registers) the information related to the input new individual identification information, and deletes the information related to the oldest individual identification information among the saved individual identification information.

If the determination result is negative in step S402 (that is, the CPU 101 determines that the same individual identification information as the currently registered individual identification information has been input), in subsequent step S406, the CPU 101 updates the management table such that the information related to the input individual identification information is moved from the predetermined current area to the area of “Past 3 (latest)” in the management table. That is, the CPU 101 updates the information on the “registration date” 3011 to the latest information. The CPU 101 does not delete the oldest individual identification information, among the currently registered individual identification information, and the information associated with the oldest individual identification information. In addition, the CPU 101 does not display a screen for prompting the user to confirm whether to register the individual identification information such as the notification screen 500. The values of the input individual identification information are not changed from the ones registered in the predetermined area.

In the processing in the flowchart, the CPU 101 may determine whether the fixing unit has been replaced. For example, before making the determination in step S401, the CPU 101 may determine whether the removal of the fixing unit has been detected. If the CPU 101 determines that the removal of the fixing unit has been detected, the processing may proceed to step S401.

In the above-described exemplary embodiment, if there is the upper limit on the number of pieces of savable individual identification information of the consumable part, when a new piece of individual identification information of a consumable part is input in the state where the upper limit is reached, a notification screen is displayed for prompting the user to confirm whether to execute the registration process based on the input information.

This reduces the unintended registration of individual identification information and achieves proper management of the consumable parts, thereby improving user convenience.

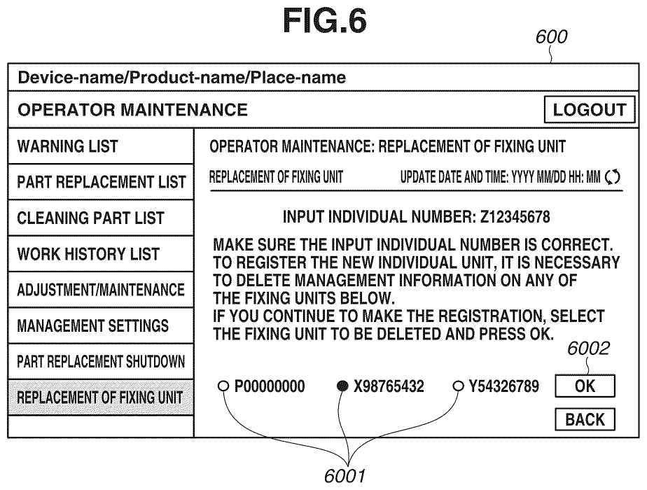

In the above-described exemplary embodiment, at the time of updating of the management table, the oldest individual identification information is always deleted. Alternatively, a selection screen may be displayed to cause the user to select the individual information to be deleted. For example, FIG. 6 is a diagram describing a notification screen for prompting the user to confirm the registration of the individual identification information of a fixing unit. A notification screen 600 includes individual selection buttons 6001. The individual selection buttons 6001 are radio buttons by which the user can select any one of pieces of individual identification information. When any one of pieces of individual identification information is selected and a confirmation button 6002 is pressed, the management table is updated in step S406 in FIG. 5 such that the information related to the selected individual identification information is deleted. Accordingly, at the time of registration of new individual identification information of a consumable part, it is possible to delete the information related to the consumable part with the individual identification information other than the oldest individual identification information.

### Other Exemplary Embodiment

Information indicating the consumption degree (not illustrated) corresponding to each piece of individual identification information may be displayed on the notification screen 500 illustrated in FIG. 4 and the notification screen 600 illustrated in FIG. 6. For example, on the notification screen 600, in addition to the individual identification information that is listed as options, information indicating the consumption degree corresponding to each individual identification information may be displayed. This makes it easy for the user to select the individual identification information to be deleted.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-093754, filed Jun. 7, 2023, which is hereby incorporated by reference herein in its entirety.

What is claimed is:

1. An image processing apparatus comprising:
a reception unit configured to provide a reception screen that receives an input of identification information of a predetermined type of part attachable to the image processing apparatus;
a registration unit configured to register the identification information in response to the input of the identification information received by the reception unit; and
a display unit configured to, if a number of pieces of the identification information previously registered in the registration unit has reached an upper limit on a registerable number in the registration unit and the reception unit has received the input of the identification information, display a notification screen that includes at least the identification information that is different from the identification information received by the reception unit and the identification information previously registered in the registration unit.

2. The image processing apparatus according to claim 1, wherein the display unit displays the notification screen if the identification information received by the reception unit is identification information that is different from the previously registered identification information.

3. The image processing apparatus according to claim 1, wherein if the number of pieces of the previously registered identification information has not reached the upper limit on the registerable number in the registration unit, the registration unit registers the identification information received by the reception unit and does not delete the previously registered identification information, and the display unit exercises control not to display the notification screen.

4. The image processing apparatus according to claim 1, wherein, on the notification screen, information indicating deletion of the previously registered identification information and registration of the identification information received by the reception unit is displayed.

5. The image processing apparatus according to claim 1, wherein the notification screen includes a registration button for permitting deletion of the identification information previously registered by the registration unit and registration of the identification information received by the reception unit, and in response to press of the registration button, the registration unit deletes the identification information previously registered by the registration unit and registers the identification information received by the reception unit.

6. The image processing apparatus according to claim 5, wherein, in response to the press of the registration button, the registration unit deletes the oldest identification information among the identification information previously registered by the registration unit, and registers the identification information received by the reception unit.

7. The image processing apparatus according to claim 5, wherein the notification screen further has a selection button displayed to select the identification information to be deleted among the identification information previously registered by the registration unit, and in response to the press of the registration button, the registration unit deletes the selected identification information and registers the identification information received by the reception unit.

8. The image processing apparatus according to claim 1, wherein if the image processing apparatus is in a predetermined state, the reception unit provides the reception screen.

9. The image processing apparatus according to claim 8, wherein the predetermined state is a state where a function of assisting a user in maintenance work is enabled.

10. The image processing apparatus according to claim 8, wherein the predetermined state is a state where a time for replacement of the predetermined type of part has come.

11. The image processing apparatus according to claim 1, wherein the predetermined type of part is a fixing unit attachable to the image processing apparatus.

12. The image processing apparatus according to claim 1, wherein information indicating a consumed state corresponding to the identification information is displayed on the notification screen.

13. The image processing apparatus according to claim 1, wherein if the identification information received by the reception unit is the previously registered identification information, the registration unit updates information associated with the previously registered identification information based on the identification information received by the reception unit, and does not delete the previously registered identification information, and the display unit exercises control not to display the notification screen.

14. A control method of an image processing apparatus, comprising:
providing a reception screen that receives an input of identification information of a predetermined type of part attachable to the image processing apparatus;
registering the identification information in response to the input of the identification information received in the providing of the reception screen; and
displaying, if a number of pieces of the identification information previously registered in the registering has reached an upper limit on a registerable number in the registering and the input of the identification information has been received in the providing of the reception screen, a notification screen that includes at least the identification information that is different from the identification information received in the providing of the reception screen and the identification information previously registered in the registering.

15. A non-transitory computer-readable storage medium storing a program for causing a computer in an image processing apparatus to execute a control method, the control method comprising:
providing a reception screen that receives an input of identification information of a predetermined type of part attachable to the image processing apparatus;
registering the identification information in response to the input of the identification information received in the providing of the reception screen; and
displaying, if a number of pieces of the identification information previously registered in the registering has reached an upper limit on a registerable number in the registering and the input of the identification information has been received in the providing of the reception screen, a notification screen that includes at least the identification information that is different from the identification information received in the providing of the reception screen and the identification information previously registered in the registering.
